(19) United States
(12) Patent Application Publication
(10) Pub. No.: US 2017/0284858 A1
(43) Pub. Date: Oct. 5, 2017

(54) ACOUSTIC SENSOR

(71) Applicant: OSRAM GmbH, Munich (DE)

(72) Inventors: Stefan Gschloessl, Nittendorf (DE); Karsten Diekmann, Rattenberg (DE); Steven Rossbach, Adorf (DE); Thorsten Vehoff, Regensburg (DE); Nina Riegel, Tegernheim (DE); Norbert Haas, Langenau (DE)

(21) Appl. No.: 15/477,149

(22) Filed: Apr. 3, 2017

(30) Foreign Application Priority Data
Apr. 5, 2016 (DE) 10 2016 205 572.0

(51) Int. Cl. G01H 1/12; G01H 9/00

(52) U.S. Cl. CPC G01H 1/12; G01H 9/00; G01N 29/2418

(57) ABSTRACT

An acoustic sensor includes a layer sequence which can be caused to vibrate, and at least one detection element which is in mechanical contact with the layer sequence and is designed to convert vibrations into electrical signals. The layer sequence is a radiation-emitting layer sequence.

### CROSS-REFERENCE TO RELATED APPLICATION

This application claims priority to German Patent Application Serial No. 10 2016 205 572.0, which was filed Apr. 5, 2016, and is incorporated herein by reference in its entirety.

### TECHNICAL FIELD

Various embodiments relate generally to an acoustic sensor and the use of a radiation-emitting layer sequence in an acoustic sensor

### BACKGROUND

In order to be able to achieve light control matching background noise, luminous means which are installed with additional, external sensors and associated electronics have hitherto been used.

### SUMMARY

An acoustic sensor includes a layer sequence which can be caused to vibrate, and at least one detection element which is in mechanical contact with the layer sequence and is designed to convert vibrations into electrical signals. The layer sequence is a radiation-emitting layer sequence.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIGS. 1 to 5 show schematic side views of embodiments of the acoustic sensor; and

FIG. 6 shows a schematic diagram relating to the function of the acoustic sensor.

### DESCRIPTION

The following detailed description refers to the accompanying drawings that show, by way of illustration, specific details and embodiments in which the invention may be practiced.

Identical, similar or identically acting elements are provided with the same reference symbols in the figures. The figures and the relative proportions of the elements illustrated in the figures should not be considered to be true to scale. Rather, individual elements may be illustrated in an excessively large form for better presentability and/or for better understanding.

Various embodiments state solutions which may improve an acoustic sensor.

An acoustic sensor is stated, having a layer sequence which can be caused to vibrate, and at least one detection element which is in mechanical contact with the layer sequence and is designed to convert vibrations into electrical signals, the layer sequence being a radiation-emitting layer sequence.

Here and below, “can be caused to vibrate” is intended to be understood as meaning the fact that the layer sequence has temporally variable deflections and/or length changes on account of an externally applied force. The applied force may include sound waves, that is to say pressure fluctuations of the atmosphere surrounding the layer sequence, but also structure-borne sound waves. Vibrations may also include structure-borne sound waves.

The layer sequence includes at least two layers arranged above one another and has a top side and an underside which are parallel to the layers and are referred to as “surfaces” below. The layer sequence also has side edges which are perpendicular or mostly perpendicular to the layers and are referred to as “side faces” below.

Here and below, “radiation-emitting” with respect to the layer sequence is used to mean the emission of electromagnetic radiation, the wavelength of which may be in the visible or invisible region, including in the IR and UV regions, of the spectrum. Here and below, electromagnetic radiation is also referred to as light. The layer sequence therefore has two surfaces, at least one surface of which is an emission face. For an external observer, the layer sequence therefore emits radiation through at least one of its two surfaces. The layer sequence may also be transparent, with the result that radiation is emitted through both surfaces, that is to say it has two emission faces.

Here and below, “mechanical contact” is understood as meaning direct and indirect mechanical contact. The detection element which is in mechanical contact with the layer sequence may have a contact point or a contact face with the layer sequence, with the result that the length and/or position changes of the surfaces or side faces of the layer sequence which are produced by the deflections of the layer sequence can be detected as a pressure change or movement.

The layer sequence is therefore simultaneously used as a sensor diaphragm for sound waves (including structure-borne sound waves) for picking up noises and as a radiation source for emitting light. Therefore, both functions, the emission of radiation and the detection of sound waves, are integrated in the acoustic sensor, with the result that they can reliably operate with one another without having to install additional external devices. In various embodiments, there is no need to fit any further additional sensors in order to be able to control the radiation source in a manner matching the acoustics. Therefore, the layer sequence can also be controlled to emit radiation without a time delay and without additionally fitting external sensors. The acoustic sensor is therefore a radiation-emitting acoustic sensor which can be used to generate light in a manner matching background noise (including structure-borne sound).

The radiation-emitting layer sequence in the acoustic sensor is therefore directly controlled by the sound and can change, for example, the brightness and/or the intensity of the emitted radiation, can alternately cause the different segments to emit light in the case of a segmented layer sequence and can accordingly change the color, that is to say the wavelength of the emitted radiation, if the layer sequence is color-tunable. A combination of these functions is also possible.

The layer sequence in the acoustic sensor can also be controlled by means of music, for example the bass rhythm in a particular frequency range. For example, the intensity and/or the wavelength of the emitted radiation can be changed depending on the frequency range.

According to one embodiment, the layer sequence may have fastening elements on at least two side faces, between which fastening elements the layer sequence is mounted in a vibratory manner. The fastening elements fix the layer sequence on at least two side faces, in such a manner that the layer sequence can be caused to vibrate on account of the effect of sound, and simultaneously enable an electrically conductive connection of the layer sequence, thus making it possible to control the latter.

In order to fix the layer sequence by means of the fastening elements, the layer sequence may have, for example, edge regions, e.g. non-radiation-emitting edge regions, each having at least one through-hole. The layer sequence can be screwed to the fastening element through the through-hole. Alternatively, the layer sequence may have edge regions which are adhesively bonded to the fastening element.

In order to connect the layer sequence in an electrically conductive manner, electrical connections are also present on the layer sequence and on the fastening element. For example, two connections may be provided for each detection element and at least two connections may be provided for the layer sequence. If the radiation-emitting layer sequence is color-tunable, more connections, for example four connections, may also be provided for the layer sequence.

The electrically conductive connection may not be rigid, that is to say may be flexible. The vibration of the layer sequence is therefore not braked and may be detected without change. Alternatively, a line printed in a meandering manner may be provided as the electrically conductive connection.

As a result of the vibratory mounting of the layer sequence between the fastening elements, the layer sequence can be caused to vibrate by means of sound waves, for example, which vibrations can again be picked up by the detection element.

According to one embodiment, at least one fastening element may include a detection element. The fastening element may be a detection element. The latter then combines the function of fixing the layer sequence and detecting the vibrations of the layer sequence.

The operation of fixing the layer sequence by means of a detection element can be carried out in a similar manner to the operation of fixing the layer sequence by means of a fastening element. Furthermore, the detection element which simultaneously has the function of a fastening element also has electrical connections for making electrical contact with the layer sequence, in a similar manner to the electrical connections of the fastening elements.

According to one embodiment, both fastening elements may be detection elements. According to another embodiment, the layer sequence may have fastening elements on all side faces, all fastening elements being detection elements. If a layer sequence is fastened between two or more detection elements, the sensitivity of the detection of vibrations can be increased since the electrical signals obtained from the detected vibrations are added.

Furthermore, the acoustic sensor may have a further layer sequence which can be caused to vibrate and is arranged beside the layer sequence, a detection element being arranged between the layer sequences as a fastening element. Here and below, “beside” is used to mean that the layer sequences have opposite side faces, but not opposite surfaces. If two layer sequences are therefore arranged beside one another, a detection element which fastens each layer sequence on one of its side faces may be present between the layer sequences as a fastening element. Furthermore, the layer sequences are fastened on their respective other side faces which are not opposite by further fastening elements, with the result that the layer sequences are mounted in a vibratory manner. The further fastening elements may include detection elements or may be in the form of detection elements. According to this embodiment, two or more layer sequences may therefore be concatenated and may be controlled in the same manner or in a different manner on the basis of the detected sound waves. It is therefore possible to produce radiation of a different wavelength or intensity inside the acoustic sensor on the basis of the effect of sound.

A direct separate response behavior of the layer sequences therefore also becomes possible even if the acoustic sensor has a plurality of layer sequences arranged beside one another. If a plurality of layer sequences arranged beside one another are present in the acoustic sensor, they have an autonomous attachment and function, but can be controlled at the same time.

Furthermore, the detection element may be arranged in a flat manner on a section of a surface of the layer sequence. In this case, the layer sequence may have fastening elements on at least two side faces, between which fastening elements the layer sequence is mounted in a vibratory manner. In this case, the detection element may be in the form of a layer. Here and below, “section” can be understood as meaning an area, for example less than 30% of the surfaces of the layer sequence. The section may be present on that surface of the layer sequence which is opposite the emission face of the layer sequence. If the layer sequence is transparent, the detection element may be so small and/or so thin that it is not perceived by an external observer as an interruption in the luminous face in this case.

According to another embodiment, the layer sequence may have an emission face, and the detection element may be arranged on that surface of the layer sequence which faces away from the emission face of the layer sequence. Fastening elements for fixing the layer sequence are then not required. Rather, the detection element is in the form of a layer and is therefore integrated as a layer on the layer sequence. In this case, the detection element may have a supporting function for the layer sequence, in which case the layer sequence can nevertheless be caused to vibrate. The detection element may cover the surface of the layer sequence to the greatest possible extent, for example up to more than 80%. If the layer sequence is caused to vibrate, the detection element integrated in the layer sequence can pick up the deflections and/or length changes as pressure, traction or movement and can convert them into electrical signals.

The detection element may include a piezo ceramic and/or a piezo film. The piezo ceramic may include barium titanate or barium zirconate, for example. The piezo film may include a polyvinylidene fluoride (PVDF) film, for example. Depending on the embodiment of the acoustic sensor, the detection element, e.g. the piezo ceramic, may be in the form of a layer or may have the form of a fastening element which can be used to fasten the layer sequence on its side faces. The piezo ceramic may pick up vibrations as pressure and may convert them into an electrical signal which may be in the mV range. The detection element may have a thickness of 2 mm, for example.

According to another embodiment, the detection element may include a vibration body and a magnet. The vibration body may include a coil. In this embodiment, either the vibration body or the magnet may be arranged in a flat manner on that surface of the layer sequence which faces away from the emission face of the layer sequence. If the layer sequence is caused to vibrate on account of sound waves, the vibration body or the magnet is also caused to vibrate and as a result moves into a magnet or into a coil of a vibration body which are present in an edge region of the vibration body or of the magnet. This movement of the vibration body relative to the magnet induces a voltage, that is to say electrical signals.

The layer sequence may have a thickness which is selected, for example, from the range of 0.1 mm to 0.2 mm, inclusive. A layer sequence of such a thickness may be easily caused to vibrate by means of sound waves.

The layer sequence of the acoustic sensor may include an optoelectronic component which is selected from light-emitting diodes (LED) and organic light-emitting diodes (OLED).

If the optoelectronic component is an LED, it includes an inorganic layer stack having an active area which emits radiation. Contacts for electrically connecting the component are additionally provided. The layer sequence may also include a flexible substrate to which the LED is applied. The flexible substrate may have a larger area than the LED itself. Two or more LEDs may also be applied to the flexible substrate. The LEDs may be soldered onto the flexible substrate, for example. The material of the flexible substrate may include polyimide. The area of an LED may be 0.2 mm×0.2 mm, for example. The area of the flexible substrate may be square or rectangular and may have a size of 3 cm×3 cm up to 13 cm×13 cm, for example, or 5 cm×15 cm, for example. Electrical contact can be made with the at least one LED via the flexible substrate, for example by vapor depositing copper wires onto the flexible substrate. The flexible substrate may have a thickness which is in the range of 25 μm to 70 μm, inclusive. In various embodiments, the flexible substrate may have a thickness of 25 μm, 50 μm or 70 μm. However, the flexible substrate may also have a thickness of up to 1 mm if the material of the flexible substrate is still flexible with such a thickness.

If the optoelectronic component is an OLED, it includes at least two layers which contain organic material and include a recombination zone which emits radiation. If the OLED is color-tunable, different recombination zones can be arranged beside one another or above one another and can be controlled individually. Furthermore, two electrode layers for electrically connecting the OLED are present. The OLED may be transparent, with the result that it is top-emitting and bottom-emitting, that is to say emits radiation through both surfaces. Alternatively, only one electrode layer of the OLED may be transparent, with the result that the OLED is either top-emitting or bottom-emitting, that is to say radiation is emitted only through one surface of the layer sequence. The OLED may have an area of 3 cm×3 cm, for example. Larger OLED areas are also conceivable, for example OLEDs having an area of 30 cm×10 cm. In various embodiments, the optoelectronic component may be a flexible OLED.

Therefore, an OLED or LED can be used as a light source and a simultaneous sensor diaphragm for noises in the acoustic sensor. There is no need to fit any further additional sensors in order to be able to control the OLED or LED in a manner matching the acoustics. If a plurality of layer sequences arranged beside one another are provided in the acoustic sensor, each OLED or LED can be individually controlled without a time delay and without additionally fitting external sensors. A direct separate response behavior of each individual OLED or LED also becomes possible, for example also in a light wall having several hundred OLEDs or LEDs. A play of light can therefore be achieved by means of acoustic control.

The acoustic control of the OLED or LED in the acoustic sensor also makes it possible to implement a switch-on function by means of a noise, for example clapping or double-clapping of the hands. Voice control is also possible and can be used to deliberately control the wavelength of the emitted radiation or a change of the wavelength of the emitted radiation. By means of voice control, the acoustic sensor can emit, for example, blue light, white light, alternately colored light, brighter light or darker light, depending on the instruction. Furthermore, control can be effected by means of music, for example by means of the bass rhythm or the volume of the music, for example during a concert or a theater performance. The acoustic sensor may also be used for a monitoring function, for example in a SmartHome, if useful noises and interfering noises are distinguished. For example, in the case of interfering noises, the OLEDs or LEDs may remain dark and may therefore be used for dark room monitoring, may be switched on or may flash in a particular color or in a particular wavelength range. The acoustic sensor may also be incorporated into textiles and other materials and composite materials. The acoustic sensor may also be entirely or partially embedded in liquid, for example in water, and may therefore enable underwater illumination, for example, which reacts to acoustic signals underwater.

The acoustic sensor may also have a microprocessor which is connected to the detection element in an electrically conductive manner and processes the electrical signals, and also a driver which is connected to the microprocessor in an electrically conductive manner and receives the processed signals, the emission of radiation by the layer sequence being able to be controlled using the driver. The microprocessor can therefore evaluate and filter the electrical signals passed to the microprocessor by the detection element. For example, it can distinguish interfering noises and useful noises from one another or can filter out subsonic noise and ultrasound. The corresponding instruction, for example switch on illumination, increase brightness or change color, is forwarded to the driver which controls the layer sequence accordingly. The microprocessor therefore contains evaluation and filter logic. The microprocessor may be controlled, for example, using a program which can be used to select different operating modes.

The acoustic sensor may also have a multiplicity of layer sequences arranged beside one another, at least one layer sequence being in mechanical contact with at least one detection element.

According to one embodiment, only one layer sequence may be in mechanical contact with at least one detection element. This layer sequence may be arranged centrally between the other layer sequences, for example. The detected vibrations and converted electrical signals may be forwarded to the microprocessor and received by the driver which in turn controls all layer sequences. For example, an OLED matrix may be installed in the acoustic sensor, in which case only one OLED is in the form of a sensor diaphragm.

According to another embodiment, all layer sequences may be in mechanical contact with at least one detection element in each case. This may be an OLED matrix, in which case each OLED can be caused to vibrate by sound waves and the vibrations of each OLED are detected by a detection element. The direction of the acoustic source can therefore be determined, for example, and source-location-based light emission can therefore be emitted. A measurement of the dynamic sound pressure can be used to modulate or adapt the brightness of the emitted radiation. Furthermore, local sound sources or mechanical vibrations may be optically represented, for example, by means of brightness, flashing frequency or emission wavelength of the OLED. Machine noises or noises which are produced in a production plant, for example, can therefore also be detected and rendered visible and can therefore contribute to better function monitoring.

The use of the acoustic sensor for the sound-controlled emission of electromagnetic radiation is also stated. In this case, the layer sequence is caused to vibrate by sound waves, for example noises, clapping, talking or music. The vibrations are converted into electrical signals by the detection element. The electrical signals are also forwarded, via an electrically conductive connection, to a microprocessor which filters and evaluates the signals. The electrical signals which are processed in this manner and include instructions for the emission of radiation are forwarded, via an electrically conductive connection, to a driver. The latter then controls, via an electrically conductive connection, the emission of radiation by the layer sequence, which may include an LED or OLED, by regulating the power supply. The layer sequence can therefore be controlled on the basis of the triggering sound waves in such a manner that the emission of radiation begins for example, that is to say the illumination is switched on, or the wavelength of the radiation, that is to say the brightness and/or the color for example, is changed.

All features disclosed with respect to the acoustic sensor also apply to its use for the sound-controlled emission of electromagnetic radiation. Conversely, features disclosed with respect to the use of the acoustic sensor also apply to the acoustic sensor.

Furthermore, the use of a radiation-emitting layer sequence as a layer sequence which can be caused to vibrate in an acoustic sensor is stated. The radiation-emitting layer sequence may be characterized by the features of the layer sequence which can be caused to vibrate, which features are disclosed with respect to the acoustic sensor. In various embodiments, the radiation-emitting layer sequence may include an optoelectronic component selected from LEDs and OLEDs. The acoustic sensor in which the radiation-emitting layer sequence is used can be characterized by the features mentioned above with respect to the acoustic sensor.

The use of a radiation-emitting layer sequence as a layer sequence which can be caused to vibrate in an acoustic sensor integrates the functions of radiation emission and detection of sound waves in one component without fitting additional sensors. The radiation-emitting layer sequence is therefore used as a sensor diaphragm in the acoustic sensor. Acoustic control of a radiation source in the acoustic sensor can therefore be achieved.

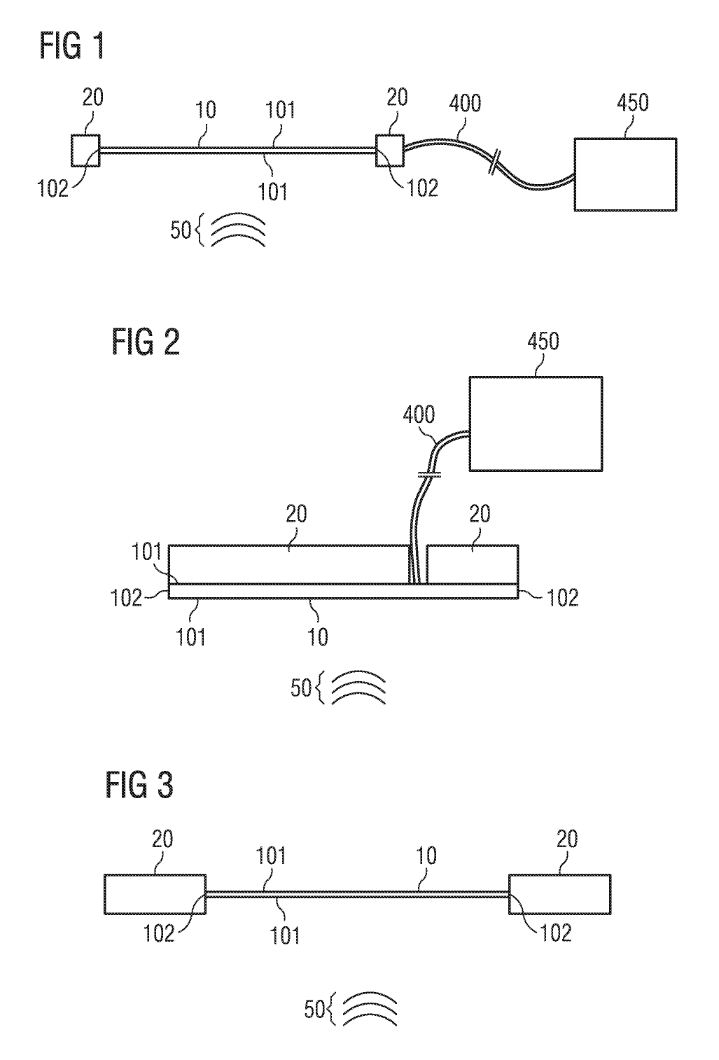

FIG. 1 shows the schematic side view of one embodiment of the acoustic sensor. The layer sequence 10 is mounted in a vibratory manner between two detection elements 20 which are simultaneously used as fastening elements. In this example, the detection elements 20 contain a piezo ceramic. The layer sequence 10 has the surfaces 101 and the side faces 102. Radiation can be emitted via one surface or both surfaces 101, while the layer sequence 10 is fastened via its side faces 102. The fastening may be effected using a screw connection or an adhesive bond between the layer sequence 10 and the detection element 20.

The detection elements 20 (shown here only for one detection element) are connected to downstream electronics 450 by means of a non-rigid electrical connection 400. In this case, the electronics 450 include the microprocessor and the driver for controlling the emission of radiation by the layer sequence 10. Also schematically illustrated are sound waves 50 which cause the layer sequence 10 to vibrate and result in length or position changes of the layer sequence 10 which are perceived by the detection elements 20 as pressure and are converted into electrical signals. The electrical signals transmitted by the detection element 20 are therefore forwarded to the microprocessor and the driver via the electrical connection 400 and the instructions from the driver are then passed to the layer sequence 10 in order to control the emission of radiation from the layer sequence 10.

The layer sequence 10 may be an OLED, e.g. a flexible OLED, or an LED. The layer sequence 10 may also include a plurality of LEDs which are arranged beside one another and are arranged together on a flexible substrate.

FIG. 2 shows another embodiment of an acoustic sensor in which the detection element 20 is attached in the form of a layer over the full area of one of the surfaces 101 of the layer sequence 10, to be precise that surface 101 of the layer sequence 10 which is not the emission face. Therefore, the layer sequence 10 is not mounted in a vibratory manner between fastening elements here, but rather a detection layer 20 is integrated in the layer sequence. The electrical signals are again forwarded to the electronics 450 via an electrical line 400 and are processed as described with respect to FIG. 1. The sound waves 50 result in a temporally variable deflection of the layer sequence 10.

The detection element 20 may include a piezo ceramic and/or a piezo film which picks up deflections and/or structure-borne sound as pressure or traction and converts it/them into electrical signals. Alternatively, the detection element 20 may include a vibration body and a magnet, in which case either the vibration body or the magnet is caused to move by the deflection of the layer sequence 10 and the relative movement of the vibration body with respect to the magnet generates electrical signals.

FIG. 3 shows the schematic side view of a further embodiment of the acoustic sensor.

For the sake of clarity, the electrical lines 400 and the electronics 450 are no longer illustrated here and in the following figures.

In this embodiment, the layer sequence 10, for example a flexible OLED having a thickness of 0.1 mm to 0.2 mm and an area of 3 cm×3 cm, is clamped on its side faces 102 between two detection elements 20 each including a piezo ceramic. Alternatively, only one of the fastening elements may also be simultaneously a detection element 20 or all side faces 102 of the layer sequence 10 may have detection elements 20 (not shown here). The sound waves 50 arriving at the surface 101 of the layer sequence 10 generate vibrations in the layer sequence 10, for example a flexible OLED, which are converted into an electrical voltage signal by the detection elements 20.

The voltage signals are processed and are used to control the emission of radiation by the layer sequence 10. The radiation can be emitted through one surface or both surfaces 101 of the layer sequence.

FIG. 4 shows the schematic side view of a further embodiment of the acoustic sensor. In this case, it is possible to see two layer sequences 10 which are arranged beside one another, that is to say with opposite side faces 102. Situated between said layer sequences is a detection element 20 which respectively fixes one side face 102 of the layer sequences 10. The respective other side face 102 is fixed by a fastening element 30. Alternatively, one fastening element or both fastening elements 30 may also be in the form of a detection element 20 (not shown here). A detection element 20 containing a piezo ceramic is therefore situated between two layer sequences 10, for example flexible OLEDs. The sound waves 50 arriving at the surface of the flexible OLED produce vibrations and therefore length changes of the layer sequences 10 which are converted into an electrical voltage signal by the detection element 20 containing the piezo ceramic. According to this embodiment, a plurality of layer sequences 10, for example a plurality of OLEDs, may be concatenated in the acoustic sensor.

The voltage signals are processed and are used to control the emission of radiation by the layer sequence 10. The radiation can be emitted through one surface or both surfaces 101 of the layer sequence.

FIG. 5 shows the schematic side view of a further embodiment of the acoustic sensor. The layer sequence 10 is clamped in a vibratory manner on its side faces 102 between two fastening elements 30. The detection element 20 is in the form of a layer and is applied to a section of a surface 101 of the layer sequence 10. The layer sequence 10 is a flexible OLED, for example, and the detection element 20 is applied to the substrate of the flexible OLED. The detection element 20 has a thickness of 2 mm, for example. The radiation is therefore emitted by the flexible OLED through the surface 101 on that side of the OLED which is opposite the detection element 20. However, emission on both sides is also conceivable. The detection element 20 may be applied to the layer sequence 10 in a flat manner, may pick up the deflections of the layer sequence 10 which are generated by the sound 50 and may convert them into an electrical voltage signal.

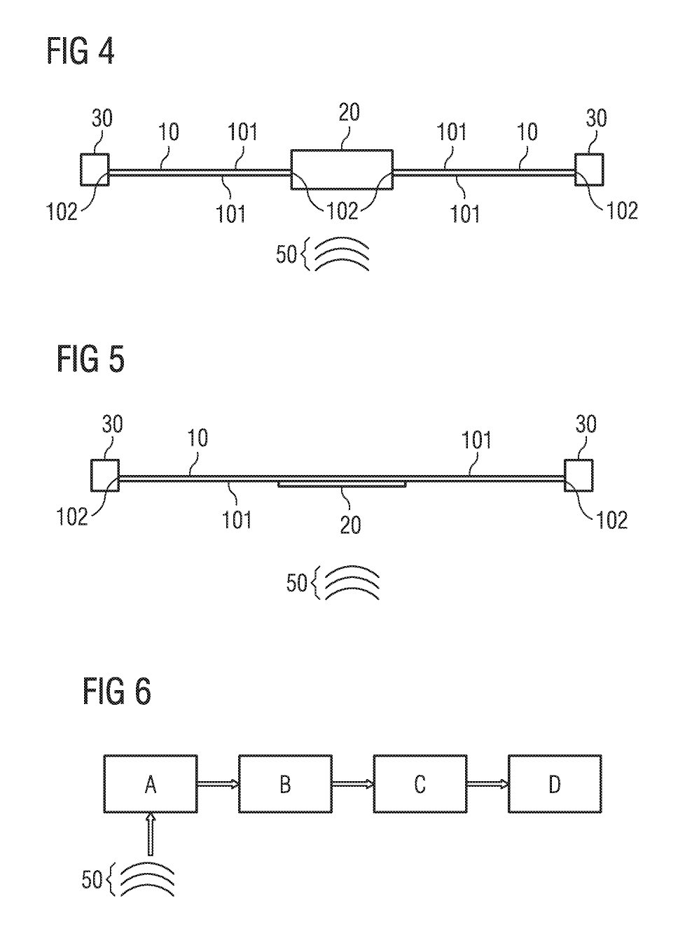

FIG. 6 shows a diagram relating to the method of operation of the acoustic sensor. Sound waves 50 are detected in a first step A) by the layer sequence 10 which can be caused to vibrate, for example an OLED or LED, that is to say said sound waves cause the layer sequence 10 to vibrate. The sound waves 50 may be, for example, noises such as clapping, talking or music. The sound waves 50 picked up by the layer sequence 10 are converted by the detection element 20 into electrical signals which are forwarded to a microprocessor in a step B). The microprocessor evaluates the signals and filters them by distinguishing interfering noises and useful noises from one another, for example. The corresponding instruction is forwarded in a step C) to the driver which controls the layer sequence 10, for example the OLED or an LED. The control is effected by regulating the current for the layer sequence 10 which accordingly emits light, does not emit light, flashes or changes color in a step D).

For example, the layer sequence 10 can be controlled by means of voice control using simple instructions, for example “blue” for blue light, “white” for white light, “random” for a continuous color change, “bright” for brighter light, “dark” for darker light. Depending on the instruction, the LED or OLED can be controlled accordingly. The layer sequence can furthermore also be controlled by music; for example, the LED or OLED may react to bass rhythms with a particular wavelength range of the emitted radiation, may emit brighter light in the case of louder music, may emit blue light for low tones, for example, and may emit yellow light for high tones.

The OLED or LED is therefore directly controlled by acoustic signals, in which case downstream filter logic can distinguish between interfering noises and useful noises, for example can also filter out subsonic noise and ultrasound, or can generate an instruction for their specific representation therefrom. The use of the OLED or LED as light source and simultaneous sensor for noises dispenses with the additional attachment of further sensors and makes it possible to control the light source in a manner matching the acoustics. It is possible to control the OLED or LED without a time delay and without additionally fitting external sensors.

It is also possible, in principle, to generate sound waves by specifically electrically exciting the acoustic sensor, which sound waves can be emitted by the radiation-emitting layer sequence.

The invention is not restricted by the description on the basis of the exemplary embodiments. Rather, the invention includes any new feature and any combination of features, which includes, in particular, any combination of features in the patent claims, even if this feature or this combination itself is not explicitly stated in the patent claims or exemplary embodiments.

### LIST OF REFERENCE SYMBOLS

10 Layer sequence

20 Detection element

30 Fastening element

50 Sound waves

400 Electrical connection

450 Electronics

101 Surface

102 Side face

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An acoustic sensor, comprising:
a layer sequence which can be caused to vibrate, and
at least one detection element which is in mechanical contact with the layer sequence and is designed to convert vibrations into electrical signals,
wherein the layer sequence is a radiation-emitting layer sequence.

2. The acoustic sensor of claim 1,
wherein the layer sequence has two surfaces, at least one surface (101) of which is an emission face.

3. The acoustic sensor of claim 1,
wherein the layer sequence has fastening elements on at least two side faces, between which fastening elements the layer sequence is mounted in a vibratory manner.

4. The acoustic sensor of claim 1,
wherein at least one fastening element comprises a detection element.

5. The acoustic sensor of claim 3, further comprising:
a further layer sequence which can be caused to vibrate and is arranged beside the layer sequence, a detection element being arranged between the layer sequences as a fastening element.

6. The acoustic sensor of claim 2,
wherein the detection element is arranged in a flat manner on a section of a surface of the layer sequence.

7. The acoustic sensor of claim 2,
wherein the layer sequence has an emission face, and
wherein the detection element is arranged on that surface of the layer sequence which faces away from the emission face of the layer sequence.

8. The acoustic sensor of claim 1,
wherein the detection element comprises at least one of a piezo ceramic or a piezo film.

9. The acoustic sensor of claim 7,
wherein the detection element comprises a vibration body and a magnet.

10. The acoustic sensor of claim 1,
wherein the layer sequence comprises an optoelectronic component which is selected from a light emitting diode and an organic light emitting diode.

11. The acoustic sensor of claim 10,
wherein the optoelectronic component is a flexible organic light emitting diode.

12. The acoustic sensor of claim 1, further comprising:
a microprocessor which is connected to the detection element in an electrically conductive manner and processes the electrical signals,
a driver which is connected to the microprocessor in an electrically conductive manner and receives the processed signals,
wherein the emission of radiation by the layer sequence is able to be controlled using the driver.

13. The acoustic sensor of claim 1,
comprising a multiplicity of layer sequences arranged beside one another,
wherein at least one layer sequence is in mechanical contact with at least one detection element.

14. The acoustic sensor of claim 1,
wherein all layer sequences are in mechanical contact with at least one detection element in each case.

15. A method of operating an acoustic sensor, the method comprising:
providing a radiation-emitting layer sequence as a layer sequence; and
causing the radiation-emitting layer sequence to vibrate in an acoustic sensor.
